(19) United States
(12) Patent Application Publication
(10) Pub. No.: US 2016/0308319 A1
(43) Pub. Date: Oct. 20, 2016

(54) DC POWER PLUG

(71) Applicant: Acer Incorporated, New Taipei City (TW)

(72) Inventors: Yu-Shih WANG, New Taipei City (TW); Yang-Kun OU, New Taipei City (TW); Wei-Yu CHEN, New Taipei City (TW); Chia-Chieh LIU, New Taipei City (TW); Chih-Yi CHEN, New Taipei City (TW)

(21) Appl. No.: 14/837,380

(22) Filed: Aug. 27, 2015

(30) Foreign Application Priority Data
Apr. 16, 2015 (TW) 104112170

(51) Int. Cl. H01R 27/02

(52) U.S. Cl. CPC H01R 27/02

(57) ABSTRACT

A DC power plug, which is adapted for being coupled to an electronic device, an external device, and an external power source, includes a wire, an external plug, and an adaptor. The wire includes a power pin set configured to be coupled to the external power source. The external plug, which is configured to be coupled to the external device, includes a first external pin set coupled to the power pin set and a second external pin set. The adaptor, which is configured to be coupled to the electronic device, includes a first adapting pin set coupled to the power pin set and a second adapting pin set coupled to the second external pin set.

### CROSS REFERENCE TO RELATED APPLICATIONS

This application claims priority of Taiwan Patent Application No. 104112170, filed on Apr. 16, 2015, the entirety of which is incorporated by reference herein.

### BACKGROUND OF THE INVENTION

1. Field of the Invention

The disclosure relates generally to a DC power plug for electronic devices, and particularly it relates to a DC power plug which is able to communicate with external devices.

2. Description of the Related Art

Since the notebook computers produced recently are much slimmer than before, engineers have been racking their brains to find appropriate placements for I/O ports in modern designs. The most common problem is that the Universal Serial Bus (USB) ports have to be omitted due to the slimmer profile of the host device.

In a best-case scenario, there should be more than 3 USB ports in a good notebook, and it is optimal to deploy at least one USB port on each of the left and right sides of the device. However, it is possible to sacrifice the number of USB ports, or to deploy the USB ports on only either the left or the right side, due to limitations caused by the thin profile of the notebook. Therefore, we need an effective device and method to improve upon the embarrassment caused by having too few USB ports.

### BRIEF SUMMARY OF THE INVENTION

For solving above problems, the invention provides a DC power plug for simultaneously transmit power and data.

An embodiment of a DC power plug, adapted for being coupled to an electronic device, an external device, and an external power source, comprises a wire, an external plug, and an adaptor. The wire comprises a power pin set configured to be coupled to the external power source. The external plug is configured to be coupled to the external device and comprises a first external pin set and a second external pin set. The first external pin set is coupled to the power pin set. The adaptor is configured to be coupled to the electronic device and comprises a first adapting pin set and a second adapting pin set. The first adapting pin set is coupled to the power pin set, and the second adapting pin set is coupled to the second external pin set.

An embodiment of an electronic system comprises a DC power plug and an electronic device. The DC power plug comprises a wire, an external plug, and an adaptor. The wire comprises a power pin set and is configured to be coupled to an external power source. The external plug is configured to be coupled to an external device and comprises a first external pin set and a second external pin set. The first external pin set is coupled to the power pin set. The adaptor comprises a first adapting pin set and a second adapting pin set. The first adapting pin set is coupled to the power pin set, and the second adapting pin set is coupled to the second external pin set. The electronic device comprises a socket, a power management device, a communication module, and a processing device. The socket is configured to be detachably placed in the adaptor. When the adaptor is detachably placed in the socket, the power management device receives the external power source through the first adapting pin set. When the adaptor is detachably placed in the socket, the communication module communicates with the external device through the second adapting pin set. The processing device is configured to manage the power management device and the communication module.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of the DC power plug in accordance with an embodiment of the invention; and

FIG. 2 is a schematic diagram of the DC power plug in accordance with an embedment of the invention; and

FIG. 3 is a block diagram of the electronic system in accordance with an embedment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

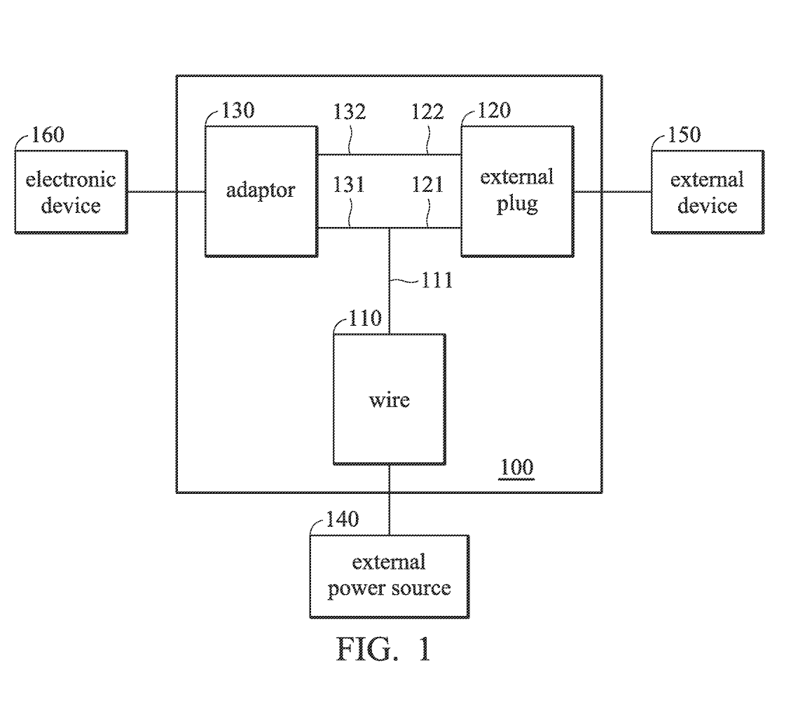

FIG. 1 is a block diagram of the DC power plug in accordance with an embodiment of the invention. As shown in FIG. 1, the DC power plug 100 includes a wire 110, an external plug 120, and an adapter 130. The wire 110 is configured to be coupled to the external power source 140, which has the power pin set 111. The external plug 120 is configured to be coupled to the external device 150, which has the first external pin set 121 and the second external pin set 122. According to an embodiment of the invention, the external device 150 includes an external drive, an external DVD player, an external mouse, and any other devices which can communicate with the electronic device 160. The adaptor 130 is configured to be coupled to the electronic device 160 and has the first adapting pin set 131 and the second adapting pin set 132.

As shown in FIG. 1, the wire 110, which is coupled to the external power source 140, is coupled to the first external pin set 121 of the external plug 120 and the first adapting pin set 131 of the adaptor 130, such that the supply voltage VDD provided by the external power source 140 is applied to the external device 150 through the power pin set 111 and the first external pin set 121, and the supply voltage VDD is also applied to the electronic device 160 through the first adapting pin set 131 of the adaptor 130.

The second external pin set 122 of the external plug 120 is coupled to the second adapting pin set 132 of the adaptor 130. Therefore, the electronic device 160 is able to communicate with the external device 150 through the second adapting pin set 132 of the adaptor 130 and the second external pin set 122 of the external plug 120. According to an embodiment of the invention, the electronic device 160 and the external device 150 conform to the specifications of Universal Serial Bus (USB), such that the electronic device 160 communicates with the external device 150 according to the specifications of Universal serial Bus.

According to an embodiment of the invention, the adaptor 130 includes at least four pins. According to an embodiment of the invention, the external plug 120 is a socket conforming to the specifications of Universal Serial Bus.

According to an embodiment of the invention, when the adaptor 130 is coupled to the electronic device 160, the external plug 120 is coupled to the external device 150, and the wire 110 is coupled to the external power source 140, the external power source 140 supplies power to the electronic device 160 and the external device 150 through the power pin set 111, the first adapting pin set 131, and the first external pin set 121. The electronic device 160 communicates with the external device 150 through the second adapting pin set 132 and the second external pin set 122.

According to another embedment of the invention, when the adaptor 130 is coupled to the electronic device 160, the external plug 120 is coupled to the external device 150, and the wire 110 is not coupled to the external power source 140, the electronic device 160 supplies power to the external device 150 through the first adapting pin set 131 and the second external pin set 121, and the electronic device 160 communicates with the external device 150 through the second adapting pin set 132 and the second external pin set 122. According to another embodiment of the invention, the external device 150 is able to supply power to the electronic device 160 through the first external pin set 121 and the first adapting pin set 131.

According to another embodiment of the invention, when the adaptor 130 is coupled to the electronic device 160, the external plug 120 is not coupled to the external device 150, and the wire 110 is coupled to the external power source 140, the external power source 140 supplies power to the electronic device 160 through the power pin set 111 and the first adapting pin set 131.

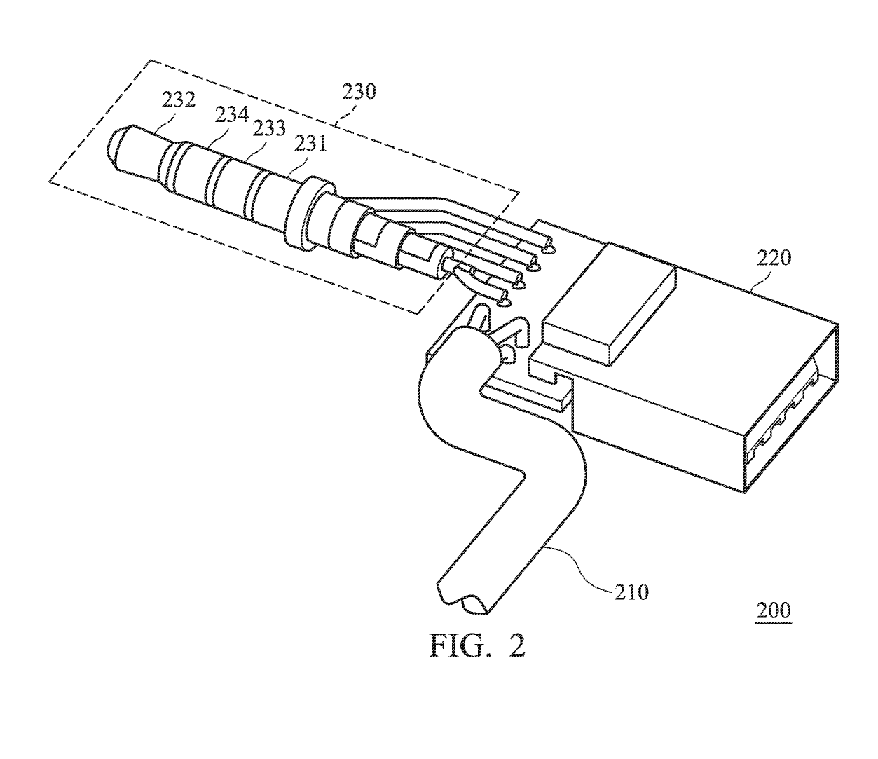

FIG. 2 is a schematic diagram of the DC power plug in accordance with an embedment of the invention. As shown in FIG. 2, the DC power plug 200 includes the wire 210, the external plug 220, and the adaptor 230. According to an embodiment of the invention, the external plug 220 is an USB connector, and the adaptor 230 is an audio connector. Since the example illustrated herein is used to explain the embodiment of the invention, the external plug 220 and the adaptor 230 can also be any other type of connector with at least four ports which is configured to simultaneously transmit power and data.

The wire 210 includes the first power pin and the second power pin (not shown in FIG. 2), and the first power pin and the second power pin are corresponding to the power pin set 111 in FIG. 1. The first power pin is configured to provide the supply voltage of the external power source 140 in FIG. 1, and the second power pin is configured to provide the reference voltage of the external power source 140 in FIG. 1.

The external plug 220 includes the first external pin and the second external pin (not shown in FIG. 2), which are corresponding to the first external pin set 121 in FIG. 1, and the third external pin and the fourth external pin (not shown in FIG. 2), which are corresponding to the second pin set 122 in FIG. 1. The first external pin is configured to be coupled to the first power pin 211 for receiving the supply voltage, and the second external pin is configured to be coupled to the second power pin 212 for receiving the reference voltage.

The adaptor 230 includes the first adapting pin 231, the second adapting pin 232, the third adapting pin 233, and the fourth adapting pin 234. The first adapting pin 231 and the second adapting pin 232 are corresponding to the first adapting pin set 131 in FIG. 1, and the third adapting pin 233 and the fourth adapting pin 234 are corresponding to the second adapting pin set 132.

The first adapting pin 231 is coupled to the first power pin for receiving the supply voltage, and the second adapting pin 232 is coupled to the second power pin for receiving the reference voltage. The third adapting pin 233 is coupled to the third external pin, and the fourth adapting pin 234 is coupled to the fourth adapting pin. According to an embodiment of the invention, the external device, which is coupled to the external plug 220, communicates with the electronic device, which is coupled to the adaptor 230, in differential mode through the third external pin coupled to the third adapting pin and the fourth external pin coupled to the fourth adapting pin, according to the specifications of Universal Serial Bus (USB).

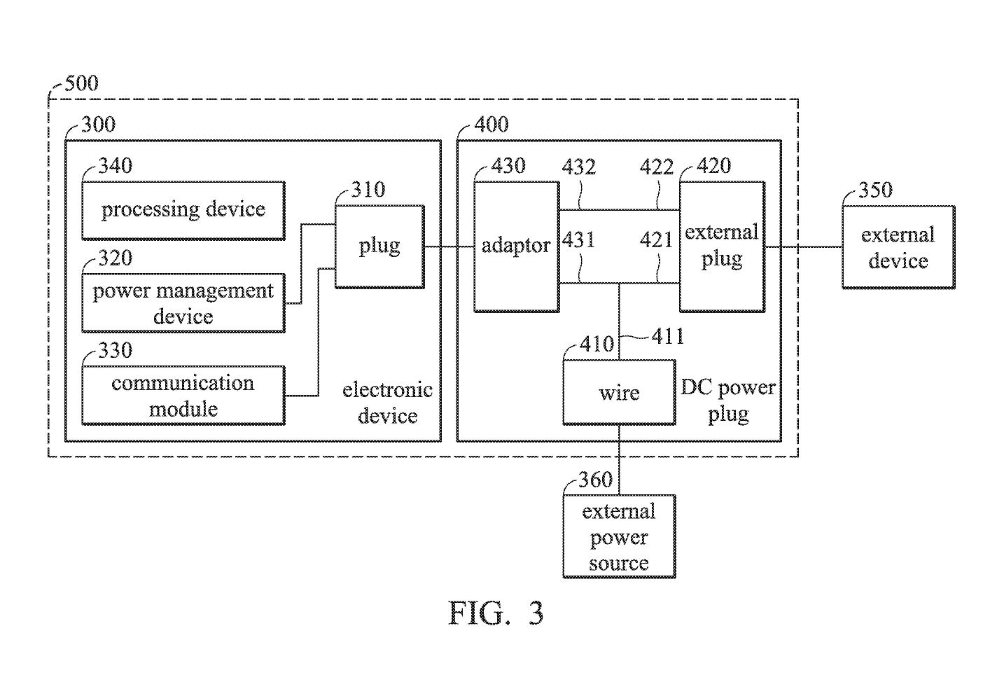

FIG. 3 is a block diagram of the electronic system in accordance with an embedment of the invention. As shown in FIG. 3, the electronic system 500 includes the electronic device 300 and the DC power plug 400. The electronic device 300 includes the plug 310, the power management device 320, the communication module 330, and the processing device 340. The DC power plug 400, as the DC power plug 100 in FIG. 1, includes the wire 410, the external plug 420, and the adaptor 430. The wire 410 has the power pin set 411, and the wire 410 is configured to be coupled to the external power source 360.

The external plug 420 is configured to be coupled to the external device 350 and includes the first external pin set 421, which is coupled to the power pin set 411, and the second external pin set 422. The adaptor 430 is configured to be detachably placed in the socket 310 and includes the first adapting pin set 431 and the second adapting pin set 432. The first adapting pin set is coupled to the power pin set 411, and the second adapting pin set 432 is coupled to the second external pin set 422.

According to an embodiment of the invention, when the adaptor 430 is detachably placed in the socket 310, the processing device 340 controls the power management device 320 to receive the supply voltage supplied by the external power source 360 through the first adapting pin set 431 coupled to the power pin set 411. According to an embodiment of the invention, when the adaptor 430 is detachably placed in the socket 310, the processing device 340 controls the communication module 330 to communicate with the external device 350 through the second adapting pin set 432 coupled to the second external pin set 422. According to an embodiment of the invention, the communication module 330 communicates with the external device 350 according to the specifications of Universal Serial Bus.

According to an embodiment of the invention, when the adaptor 430 is detachably placed in the socket 310, the external plug 420 is coupled to the external device 350, and the wire 410 is coupled to the external power source 360, the external power source 360 supplies power to the power management device 320 through the first adapting pin set 411, and to the external device 350 through the first external pin set 421. In addition, the processing device 340 controls the communication module 330 to communicate with the external device 350 through the second adapting pin set 432 and the second external pin set 422.

According to another embodiment of the invention, when the adaptor 430 is detachably placed in the socket 310, the external plug 420 is coupled to the external device 350, and the wire 411 is not coupled to the external power source 360, the processing device 340 controls the power management device 320 to supply power to the external device 350 through the first adapting pin set 431 and the first external pin set 421, and controls the communication module 320 to communicate with the external device 350 through the second adapting pin set 432 and the second external pin set 422. According to another embodiment of the invention, the external device 350 can also supply power to the power management device 320 through the first external pin set 421 and the first adapting pin set 431.

According to another embodiment of the invention, when the adaptor 430 is detachably placed in the socket 310, the external plug 420 is not coupled to the external device 350, and the wire 410 is coupled to the external power source 360, the external power source 360 supplies power to the power management device 320 through the power pin set 411 and the first adapting pin set 431.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A DC power plug, adapted for being coupled to an electronic device, an external device, and an external power source, comprising:
a wire, comprising a power pin set configured to be coupled to the external power source;
an external plug, configured to be coupled to the external device and comprising a first external pin set and a second external pin set, wherein the first external pin set is coupled to the power pin set; and
an adaptor, configured to be coupled to the electronic device and comprising a first adapting pin set and a second adapting pin set, wherein the first adapting pin set is coupled to the power pin set, and the second adapting pin set is coupled to the second external pin set.

2. The DC power plug of claim 1, wherein the electronic device communicates with the external device through the second external pin set and the second adapting pin set, wherein the second external pin set and the second adapting pin set conform to a specifications of Universal Serial Bus.

3. The DC power plug of claim 1, wherein
when the adaptor is coupled to the electronic device, the external plug is coupled to the external device, and the wire is coupled to the external power source, the external power source supplies power to the electronic device and the external device through the first adapting pin set and the first external pin set, and the electronic device communicates with the external device through the second adapting pin set and the second external pin set, wherein
when the adaptor is coupled to the electronic device, the external plug is coupled to the external device, and the wire is not coupled to the external power source, the electronic device supplies power to the external device through the first adapting pin set and the first external pin set, and the electronic device communicates with the external device through the second adapting pin set and the second external pin set, wherein
when the adaptor is coupled to the electronic device, the external plug is not coupled to the external device, and the wire is coupled to the external power source, the external power source supplies power to the electronic device through the power pin set and the first adapting pin set.

4. The DC power plug of claim 1, wherein the power pin set comprises:
a first power pin, configured to be coupled to a supply node of the external power source; and
a second power pin, configured to be coupled to a reference node of the external power source, wherein the external power source provides a supply voltage on the supply node, and provides a reference voltage on the reference node.

5. The DC power plug of claim 4, wherein the first external pin set comprises:
a first external pin, configured to be coupled to the first power pin; and
a second external pin, configured to be coupled to the second power pin, wherein
the second external pin set comprises:
a third external pin; and
a fourth external pin, wherein the external device communicates with the electronic device in differential mode through the third external pin and the fourth external pin.

6. The DC power plug of claim 5, wherein the first adapting pin set comprises:
a first adapting pin, coupled to a supply node of the power pin set for receiving a supply voltage of the supply node; and
a second adapting pin, coupled to a reference node of the power pin set for receiving a reference voltage of the reference node, wherein
the second adapting pin set comprises:
a third adapting pin, coupled to the third external pin; and
a fourth adapting pin, coupled to the fourth external pin, wherein the electronic device communicates with the external device in differential mode through the third adapting pin and the fourth adapting pin.

7. An electronic system, comprising:
a DC power plug, comprising:
a wire, comprising a power pin set and configured to be coupled to an external power source;
an external plug, configured to be coupled to an external device and comprising a first external pin set and a second external pin set, wherein the first external pin set is coupled to the power pin set; and
an adaptor, comprising a first adapting pin set and a second adapting pin set, wherein the first adapting pin set is coupled to the power pin set, and the second adapting pin set is coupled to the second external pin set; and
an electronic device, comprising:
a socket, configured to be detachably placed in the adaptor;
a power management device, wherein when the adaptor is detachably placed in the socket, the power management receives the external power source through the first adapting pin set;
a communication module, wherein when the adaptor is detachably placed in the socket, the communication module communicates with the external device through the second adapting pin set; and
a processing device, configured to manage the power management device and the communication module.

8. The electronic system of claim 7, wherein the second external pin set and the second adapting pin set conform to the specifications of Universal Serial Bus.

9. The electronic system of claim 7, wherein
when the adaptor is detachably placed in the socket, the external plug is coupled to the external device, and the wire is coupled to the external power source, the external power source supplies power to the electronic device and the external device through the first adapting pin set and the first external pin set, and the electronic device communicates with the external device through the second adapting pin set and the second external pin set, wherein
when the adaptor is detachably placed in the socket, the external plug is coupled to the external device, and the wire is not coupled to the external power source, the electronic device supplies power to the external device through the first adapting pin set and the first external pin set, and the electronic device communicates with the external device through the second adapting pin set and the second external pin set, wherein
when the adaptor is detachably placed in the socket, the external plug is not coupled to the external device, and the wire is coupled to the external power source, the external power source supplies power to the electronic device through the power pin set and the first adapting pin set.

10. The electronic system of claim 7, wherein the power pin set comprises:
a first power pin, configured to be coupled to a supply node of the external power source; and
a second power pin, configured to be coupled to a reference node of the external power source, wherein the external power source supplies a supply voltage on the supply node, and supplies a reference voltage on the reference node.

11. The electronic system of claim 10, wherein the first external pin set comprises:
a first external pin, configured to be coupled to the first power pin; and
a second external pin, configured to be coupled to the second power pin, wherein
the second external pin set comprises:
a third external pin; and
a fourth external pin, wherein the external device communicates with the electronic device in differential mode through the third external pin and fourth external pin.

12. The electronic system of claim 11, wherein the first adapting pin set comprises:
a first adapting pin, coupled to a supply node of the power pin set for receiving a supply voltage of the supply node; and
a second adapting pin, coupled to a reference node of the power pin set for receiving a reference voltage of the reference node, wherein
the second adapting pin set comprises:
a third adapting pin, coupled to the third external pin; and
a fourth adapting pin, coupled to the fourth pin, wherein the electronic device communicates with the electronic device in differential mode through the third adapting pin and the fourth adapting pin.
